(19) United States
(12) Patent Application Publication
(10) Pub. No.: US 2002/0050789 A1
(43) Pub. Date: May 2, 2002

(54) AC PALC display device with transparent dielectric

(76) Inventors: Kevin J. Ilcisin, Beaverton, OR (US); Thomas S. Buzak, Beaverton, OR (US)

Correspondence Address: Tektronix, Inc., P.O. Box 500 (50-LAW), Beaverton, OR, 97077-0001, US

(21) Appl. No.: 10/015,726

(22) Filed: Nov. 1, 2001

Related U.S. Application Data
(60) Provisional application No. 60/245,644, filed on Nov. 2, 2000.

(51) Int. Cl. H01J 17/49

(52) U.S. Cl. 313/582

(57) ABSTRACT

A plasma addressed display or storage device includes a substrate, at least two plasma electrodes on an upper surface of the substrate, and a thin sheet of substantially non-depolarizing transparent dielectric material attached to the substrate and in contact with the plasma electrodes.

### CROSS REFERENCE TO RELATED APPLICATION

This application claims the benefit of U.S. Provisional Application No. 60/245,644, filed Nov. 2, 2000.

### BACKGROUND OF THE INVENTION

This invention relates to a plasma addressed liquid crystal (PALC) device.

U.S. Pat. No. 5,077,553 discloses apparatus for addressing data storage elements. A practical implementation of the apparatus shown in U.S. Pat. No. 5,077,553 is illustrated schematically in FIG. 1 of the accompanying drawings.

The display panel shown in FIG. 1 comprises, in sequence from below, a polarizer 2, a lower substrate 4, ribs 6, a cover sheet 8 (commonly known as a microsheet), a layer 10 of electro-optic material, an array of parallel transparent data drive electrodes (only one of which, designated 12, can be seen in the view shown in FIG. 1), an upper substrate 14 carrying the data drive electrodes, and an upper polarizer 16. In the case of a color display panel, the panel includes color filters (not shown) between the layer 10 and the upper substrate 14. The panel may also include layers for improving viewing angle and for other purposes. The ribs 6, which are formed from insulating material, define multiple parallel channels 20 between the lower substrate and the cover sheet. The channels 20 are filled with an ionizable gas, such as helium. Two plasma electrodes (an anode 24 and a cathode 26) are provided in each of the channels 20. The channels 20 are orthogonal to the data drive electrodes and the region where a data drive electrode crosses a channel (when viewed perpendicularly to the panel) forms a discrete panel element 28. Each panel element can be considered to include elements of the layer 10 and the lower and upper polarizers 2 and 16. The region of the upper surface of the display panel that bounds the panel element constitutes a single pixel 30 of the display panel.

When the anode 24 in one of the channels is connected to a reference potential and a suitably more negative voltage is applied to the cathode 26 in that channel, the gas in the channel forms a plasma which provides a conductive path to the reference potential at the lower surface of the cover sheet 6. If a data drive electrode is at the reference potential, there is no significant electric field in the volume element of electro-optic material in the panel element at the crossing of the channel and the data drive electrode and the panel element is considered to be off, whereas if the data drive electrode is at a substantially different potential from the reference potential, there is a substantial electric field in that volume element of electro-optic material and the panel element is considered to be on.

It will be assumed in the following description, without intending to limit the scope of the claims, that the lower polarizer 2 is a linear polarizer and that its plane of polarization can be arbitrarily designated as being at 0° relative to a reference plane, that the upper polarizer 16 is a linear polarizer having its plane of polarization at 90°, and that the electro-optic material rotates the plane of polarization of linearly polarized light passing therethrough by an angle which is a function of the electric field in the electro-optic material. When the panel element is off, the angle of rotation is 90°; and when the panel element is on, the angle of rotation is zero.

The panel is illuminated from the underside by an extended light source 34 which emits unpolarized white light. A rear glass diffuser 18 having a scattering surface may be positioned between the light source and the panel in order to provide uniform illumination of the panel. The light that enters a given panel element from the source is linearly polarized at 0° by the lower polarizer 2 and passes sequentially through the channel member 4, the channel 20, the cover sheet 6, and the volume element of the electro-optic material toward the upper polarizer 16 and a viewer 32. If the panel element is off, the plane of polarization of linearly polarized light passing through the volume element of electro-optic material is rotated through 90°, and therefore the plane of polarization of light incident on the upper polarizer element is at 90°. The light is passed by the upper polarizer element and the pixel is illuminated. If, on the other hand, the panel element is on, the plane of polarization of the linearly polarized light is not changed on passing through the volume element of electro-optic material. The plane of polarization of light incident on the upper polarizer element is at 0° and therefore the light is blocked by the upper polarizer element and the pixel is dark. If the electric field in the volume element of electro-optic material is intermediate the values associated with the panel element being off and on, light is passed by the upper polarizer element with an intensity which depends on the electric field, allowing a gray scale to be displayed.

A discharge that is initiated in an ionizable gas between two electrodes that are both exposed to the gas is known as a DC discharge. The conventional display panel shown in FIG. 1 employs a DC discharge. A discharge can be initiated in an ionizable gas even if at least one of the plasma electrodes is electrically insulated from the ionizable gas. Such a discharge is known as an AC discharge. A PALC device that employs an AC discharge is referred to as an AC PALC device. If only one plasma electrode is insulated then the PALC device is referred to as a hybrid AC PALC device. If both plasma electrodes are insulated then the PALC device is referred to as a pure AC PALC device.

It has been proposed that the plasma electrodes of a pure AC PALC device should be isolated from the ionizable gas by a dielectric layer applied using either of two methods. In accordance with one method the dielectric is applied to the channel electrodes formed in an etched channel array by spraying the dielectric onto the electrodes in the form of a glass frit powder and liquid binder solution. The other method involves depositing a blanket layer of dielectric paste over the plasma electrodes arrayed on a planar glass substrate using a screen printing process. In both methods the processing of the dielectric layer is completed by fusing the material under high temperature.

Because both conventional methods fuse the dielectric material over an electrode substrate in order to complete the formation of the layer, the plasma electrodes on the substrate surface are also exposed to the high temperatures of the fusion process. Those portions of the plasma electrodes not covered by the dielectric can become oxidized during this process. In addition, the dielectric material can chemically damage those portions of the plasma electrodes in direct contact with the material during the high temperature processing.

The contrast ratio of a PALC display panel is expressed as the ratio of the intensity of transmitted light observed when a pixel or a collection of pixels is turned on, to that intensity observed when the pixel or collection of pixels is turned off. The magnitude of the contrast ratio of a PALC display is determined, in large part, by the degree to which the polarization of the light exiting the polarizer 2 in FIG. 1 is destroyed by the materials forming the display.

The dielectric material deposited by either of the methods described above for the fabrication of an AC PALC display can depolarize the light transmitted through it to varying degrees.

The manufacturing costs associated with either of the methods described above can contribute substantially to the overall cost of producing the display. The costs associated with the methods described above include, but are not limited to, the purchase and maintenance of the necessary capital equipment used to deposit and process the layers and the time required to process the layers.

### SUMMARY OF THE INVENTIOM

In accordance with a first aspect of the invention there is provided an intermediate product in the manufacture of a plasma addressed display or storage device, comprising a substrate, at least two plasma electrodes on an upper surface of the substrate, and a thin sheet of substantially non-depolarizing transparent dielectric material attached to the upper surface of the substrate and in contact with the plasma electrodes.

In accordance with a second aspect of the invention there is provided a method for fabricating an intermediate product in the manufacture of a plasma addressed display or storage device, said method comprising providing a substrate having at least two-plasma electrodes on an upper surface,

placing a thin sheet of substantially non-depolarizing transparent dielectric material over said plasma electrodes and in contact therewith, and attaching the thin sheet to said substrate.

In accordance with a third aspect of the invention there is provided a plasma addressed display or storage device comprising a substrate, at least two plasma electrodes on an upper surface of the substrate, a thin sheet of substantially non-depolarizing transparent dielectric material attached to the substrate and in contact with the plasma electrodes, a cover sheet spaced from the thin sheet, ionizable gas between the cover sheet and the thin sheet, an array of data drive electrodes, the cover sheet being between the data drive electrodes and the substrate, and a layer of electro-optic material between the data drive electrodes and the cover sheet.

In accordance with a fourth aspect of the invention there is provided a discrete intermediate product in the manufacture of a plasma addressed display or storage device, comprising a thin sheet of transparent dielectric material, a cover sheet spaced from the thin sheet, and an ionizable gas between the cover sheet and the thin sheet.

In accordance with a fifth aspect of the invention there is provided a method for fabricating an intermediate product in the manufacture of a plasma addressed display or storage device, said method comprising providing a discrete thin sheet of transparent dielectric material, providing a cover sheet spaced from the thin sheet, forming a peripheral bond between the thin sheet and the cover sheet, introducing an ionizable gas into the space between the thin sheet and the cover sheet, and sealing the space between the thin sheet and the cover sheet.

In accordance with a sixth aspect of the invention there is provided a method for fabricating an intermediate product in the manufacture of a plasma addressed display or storage device, said method comprising providing a discrete thin sheet of transparent dielectric material, providing a cover sheet spaced from the thin sheet, and forming a peripheral seal between the thin sheet and the cover sheet in an atmosphere of an ionizable gas.

In accordance with a seventh aspect of the invention there is provided a plasma addressed display or storage device comprising a substrate, at least two plasma electrodes on an upper surface of the substrate, a discrete thin sheet assembly composed of a cover sheet, a thin sheet of transparent dielectric material spaced from the cover sheet, an ionizable gas in the space between the cover sheet and the thin sheet, the thin sheet assembly being attached to the upper surface of said substrate with the thin sheet in contact with the plasma electrodes, an array of data drive electrodes, the thin sheet assembly being between the data drive electrodes and the substrate, and a layer of electro-optic material between the data drive electrodes and the top surface of the thin sheet assembly.

### BRIEF DESCRIPTION OF THE DRAWINGS

For a better understanding of the invention, and to show how the same may be carried into effect, reference will now be made, by way of example, to the accompanying drawings, in which

FIG. 1 is a partial sectional view of a PALC display in accordance with the prior art,

FIG. 2 is a partial sectional view of an initial stage of assembly of a PALC display panel in accordance with a first embodiment of the present invention,

FIG. 3 is a partial sectional view of an intermediate stage of assembly of a PALC display panel in accordance with the first embodiment of the present invention,

FIG. 4 is a partial sectional view of the final stage of assembly of a PALC display panel in accordance with the first embodiment of the present invention,

FIG. 5 is a partial sectional view of an initial stage of assembly of a PALC display panel in accordance with a second embodiment of the present invention, and

FIG. 6 is a partial sectional view of the final stage of assembly of a PALC display panel in accordance with the second embodiment of the present invention.

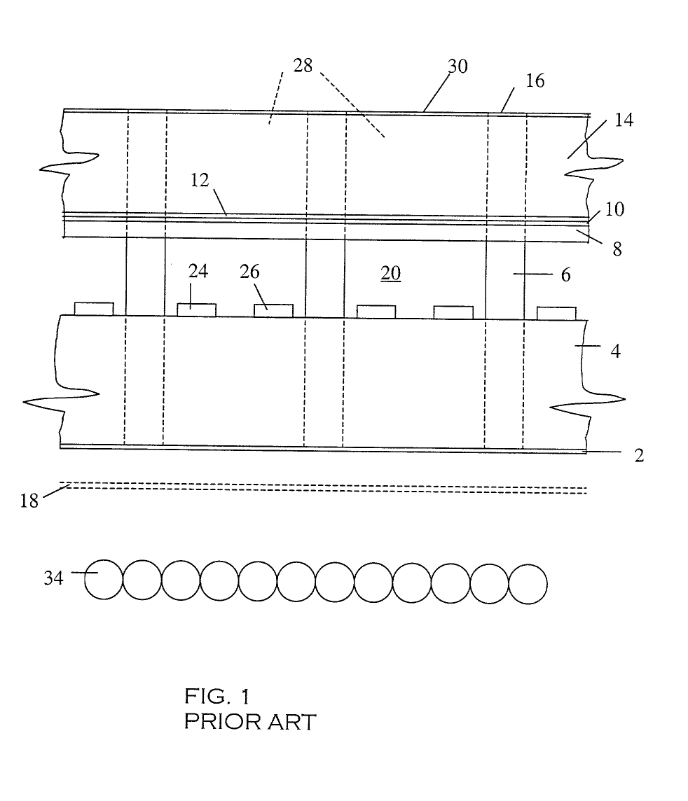

In the several figures of the drawings, like reference numerals designate like or corresponding components.

In this specification, words of orientation and position, such as lower and upper, are used to establish orientation and position relative to the drawings and are not intended to be limiting in an absolute sense. Thus, a surface that is described as upper in the specification may correspond, in a practical implementation of the invention, to a lower surface or a vertical surface, which is neither upper nor lower.

### DETAILED DESCRIPTION

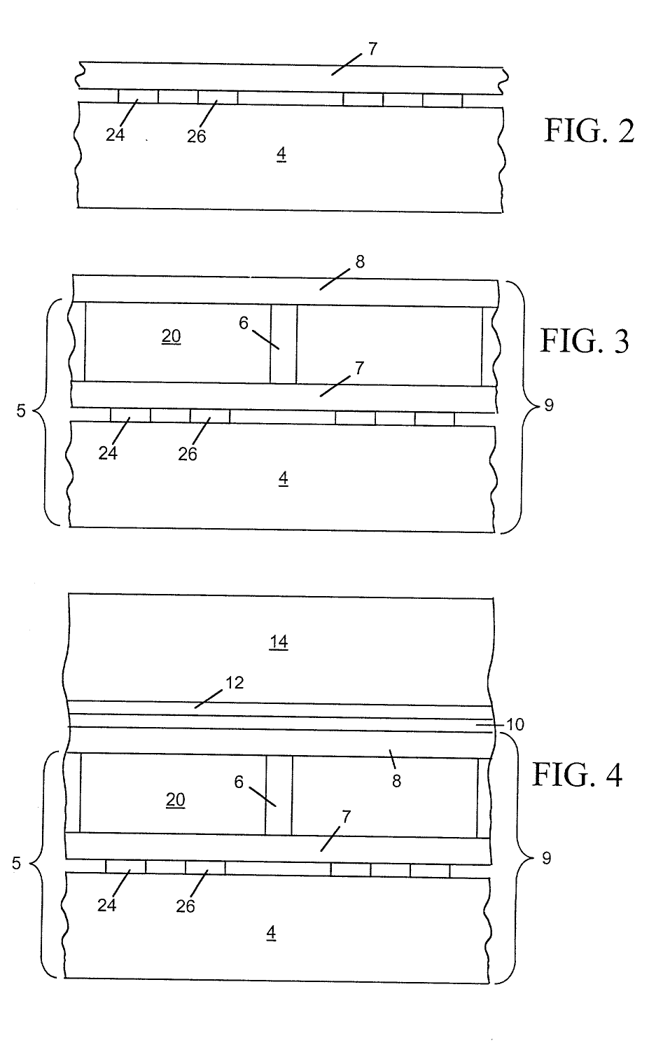

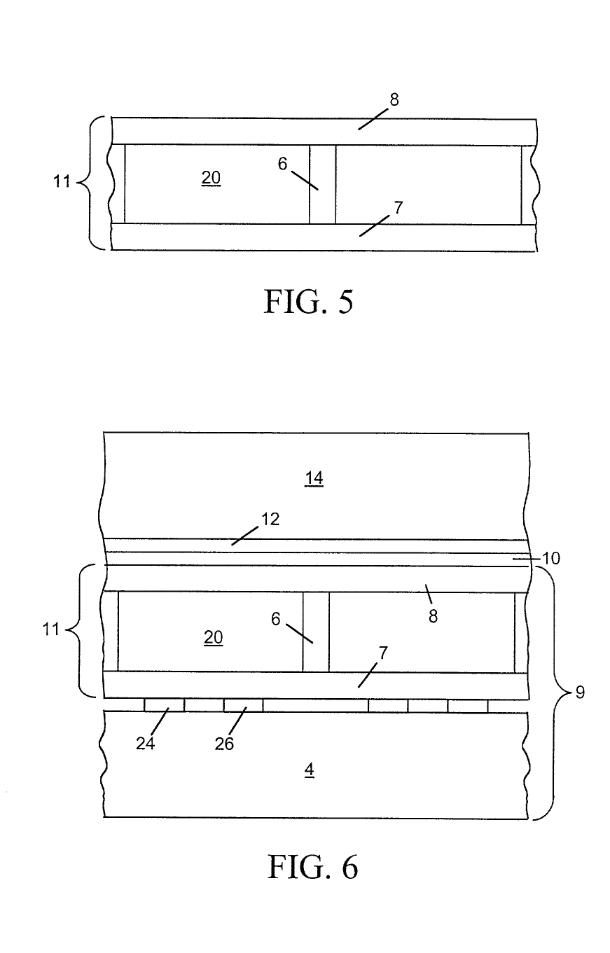

FIGS. 2, 3 and 4 illustrate a PALC display panel in accordance with the first embodiment of the invention. FIGS. 5 and 6 illustrate a PALC display panel in accordance with the second embodiment of the invention.

Referring to FIG. 2, in accordance with the first embodiment of the invention, a thin sheet 7 of transparent glass is attached to a lower substrate assembly comprising a substrate 4 and an array of plasma electrodes 24, 26 formed on the upper surface of the substrate 4. The sheet 7, which typically is less than about 100 μm in thickness, is in contact with the plasma electrodes 24, 26.

Referring to FIG. 3, spacers 6 are then formed on the exposed surface of sheet 7. The spacers 6 may consist of ribs formed from an insulating material using a screen printing process. Another possibility is to employ glass fibers as the spacers 6. The fibers would be placed on the sheet 7 at the locations normally occupied by the ribs, i.e. between one pair of plasma electrodes 24, 26 and an adjacent pair of plasma electrodes.

Alternatively, in the case of shallow channels (see U.S. Provisional Application No. 60/224,040), the spacers 6 may consist of glass spheres distributed essentially at random over the surface of the sheet 7.

In reference again to FIG. 3, a.cover sheet 8 is attached to the structure 5 consisting of the lower substrate 4, sheet 7 and spacers 6 to form a channel subassembly 9. An ionizable gas is introduced into the channels 20. Then the channels 20 are sealed from the exterior of the channel subassembly 9 by the formation of a peripheral glass frit seal (not shown).

In reference to FIG. 4, the channel subassembly 9 is attached to the upper substrate subassembly, composed of the upper substrate 14 and the data drive electrodes 12. Liquid crystal material is introduced into the space between the data drive electrodes 12 and the upper surface of the channel subassembly 9, to form the layer 10 and complete the PALC display panel.

In the second embodiment, shown in FIGS. 5 and 6, the spacers 6 are fabricated on the surface of a thin sheet 7 of transparent glass using a screen printing process. A cover sheet 8 is then attached to the assembly consisting of the spacers 6 and the sheet 7 to form a glass sheet subassembly 11. A glass frit seal (not shown), which includes a route or means through which to introduce gas into the channels 20, is then formed around the periphery of the subassembly 11. An ionizable gas is introduced into the channels 20 of the subassembly 11 and the seal is then closed. Alternatively, the subassembly 11 may be formed and then peripherally sealed in an atmosphere of an ionizable gas. In either case, the channels 20 of subassembly 11 are filled with an ionizable gas and are sealed from the exterior of the subassembly.

Alternatively, in reference to FIG. 5, the spacers 6 may consist of glass fibers attached to the surface of sheet 7. Furthermore, as noted above for the case of shallow channels, the spacers 6 may consist of glass spheres distributed essentially at random over the surface of sheet 7.

Referring to FIG. 6, the subassembly 11 is then attached to a lower substrate assembly comprising a lower substrate 4 and an array of plasma electrodes 26, 24 to form a channel subassembly 9. The subassembly 9 is then attached to the upper substrate subassembly, composed of the upper substrate 14 and the data drive electrodes 12. Liquid crystal material is introduced into the space between the data drive electrodes 12 and the upper surface of the channel subassembly 9, to form the layer 10 and complete the PALC display panel.

Given that both embodiments of the present invention are AC PALC devices it may be desirable to include a layer of electron emissive material on the upper surface of the thin sheet 7. A suitable material for this purpose is magnesium oxide because it is transparent and therefore does not impair the transmissivity of the panel.

The methods described above of providing the dielectric layer for an AC PALC device have significant advantages over the methods previously proposed. In particular, the methods provide for a lower cost means of manufacturing the dielectric layer. The sheet 7 is attached as a unit and requires only minor modifications of existing fixtures to allow for rapid implementation of the methods. Furthermore, the same material can be used for both the thin sheet 7 and the cover sheet 8. Such material, commonly known as microsheet, is commercially available in thicknesses from 30 μm to a few hundred micrometers.

In addition, the transparent nature of sheet 7 does not cause substantial depolarization of the polarized light transmitted through the display panel. This is in contrast to the substantial depolarization effects that result from the opaque nature of the fused glass frit dielectric layers that have previously been proposed.

Furthermore, the transparent nature of sheet 7 has negligible impact on the intensity of the light transmitted through the display. This is in contrast to the varying degrees of opacity found in the dielectric layers fabricated using either of the methods described above.

Moreover, the process described with reference to FIGS. 5 and 6 is simplified relative to previously proposed methods by eliminating the need for high temperature processing of the display assembly after the step of forming the glass sheet subassembly 11. For example, the attachment of the subassembly 11 to the substrate 4 can now be accomplished with epoxy and accordingly the dielectric layer is provided over the plasma electrodes without subjecting the plasma electrodes to high temperature processing. Because the peripheral seal of the subassembly 11 is formed before the step of attaching the subassembly 11 to the substrate 4, the plasma electrodes 24, 26 on the substrate 4 are not damaged by the higher temperatures required to form the peripheral seal of the subassembly 11.

It will be appreciated that the invention is not restricted to the particular embodiments that have been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A plasma addressed display or storage device comprising:
a substrate,
at least two plasma electrodes on an upper surface of the substrate,
a thin sheet of substantially non-depolarizing transparent dielectric material attached to the substrate and in contact with the plasma electrodes,
a cover sheet spaced from the thin sheet,
ionizable gas between the cover sheet and the thin sheet,
an array of data drive electrodes, the cover sheet being between the data drive electrodes and the substrate, and
a layer of electro-optic material between the data drive electrodes and the cover sheet.

2. A plasma addressed display or storage device according to claim 1, wherein the cover sheet is spaced from the thin sheet of transparent dielectric material by insulating ribs.

3. A plasma addressed display or storage device according to claim 1, wherein the cover sheet is spaced from the thin sheet of transparent dielectric material by insulating fibers.

4. A plasma addressed display or storage device according to claim 1, wherein the cover sheet is spaced from the thin sheet of transparent dielectric material by insulating spheres.

5. A plasma addressed display or storage device comprising:
a substrate,
at least two plasma electrodes on an upper surface of the substrate,
a discrete th in sheet assembly composed of a cover sheet, a thin sheet of transparent dielectric material spaced from the cover sheet, an ionizable gas in the space between the cover sheet and the thin sheet, the thin sheet assembly being attached to the upper surface of said-substrate with the thin sheet in contact with the plasma electrodes,
an array of data drive electrodes, the thin sheet assembly being between the data drive electrodes and the substrate, and
a layer of electro-optic material between the data drive electrodes and the top surface of the thin sheet assembly.

6. A plasma addressed display or storage device according to claim 5, wherein the cover sheet is spaced from the thin sheet of transparent dielectric material by insulating ribs.

7. A plasma addressed display or storage device according to claim 5, wherein the cover sheet is spaced from the thin sheet of transparent dielectric material by insulating fibers.

8. A plasma addressed display or storage device according to claim 5, wherein the cover sheet is spaced from the thin sheet of transparent dielectric material by insulating spheres.
